(19) United States
(12) Patent Application Publication
(10) Pub. No.: US 2025/0201871 A1
(43) Pub. Date: Jun. 19, 2025

(54) THERMOPLASTIC WELDED FLOW BATTERY POWER MODULE

(71) Applicant: ESS Tech, Inc., Wilsonville, OR (US)

(72) Inventor: Sean Casey, Oregon City, OR (US)

(21) Appl. No.: 18/961,220

(22) Filed: Nov. 26, 2024

Related U.S. Application Data
(60) Provisional application No. 63/610,333, filed on Dec. 14, 2023.

(51) Int. Cl. H01M 8/0273; H01M 8/026; H01M 8/18; H01M 8/248

(52) U.S. Cl. CPC H01M 8/0273; H01M 8/026; H01M 8/188; H01M 8/248

(57) ABSTRACT

Systems and methods are provided for a cell of a redox flow battery system. The electrode cell includes a membrane frame assembly, a bipolar plate frame assembly, and a thermal weld positioned between the membrane frame assembly and the bipolar plate frame assembly. The thermal weld includes material from a frame of the membrane frame assembly and a frame of the bipolar plate frame assembly.

### CROSS REFERENCE TO RELATED APPLICATIONS

The present application claims priority to U.S. Provisional Application No. 63/610,333 entitled “THERMOPLASTIC WELDED FLOW BATTERY POWER MODULE” filed Dec. 14, 2023. The entire contents of the above identified application(s) are hereby included by reference for all purposes.

### FIELD

The present description relates generally to systems for a power module stack of a redox flow battery.

### BACKGROUND AND SUMMARY

Redox flow batteries are suitable for grid-scale storage applications due to their capability for scaling power and capacity independently, as well as for charging and discharging over thousands of cycles with reduced performance losses in comparison to conventional battery technologies. An all-iron hybrid redox flow battery is particularly attractive due to incorporation of low-cost, earth-abundant materials. In general, iron redox flow batteries (IFBs) rely on iron, salt, and water for electrolyte, thus including simple, earth-abundant, and inexpensive materials, and eliminating incorporation of harsh chemicals and reducing an environmental footprint thereof.

As one example, power of a redox flow battery may be scaled by a power module including multiple cells, each cell formed of two plates. The plates include ridges which delineate flow channels therebetween when the plates are in face sharing contact and coupled by an adhesive seal. However, the adhesive seal demands an additional plasma pre-treatment step before the adhesive is applied and curing of the adhesive demands several days. Quality checks of the power module may not be performed until the curing is finished. Additionally, the plates include active areas that are divided into multiple segments and coupled to a frame by an elastic flange. The multiple active areas demand additional parts and joining locations. Further, placing and manipulating the elastic flange may be difficult to automate due to lack of rigidity.

The inventors have recognized the abovementioned drawbacks of previous power modules and developed systems and methods for an electrode cell of a redox flow battery system that at least partially overcomes the drawbacks. In one example, a cell of a redox flow battery system, comprises a membrane frame assembly and bipolar plate frame assembly, a thermal weld positioned between the membrane frame assembly and the bipolar plate frame assembly, the thermal weld including material from a frame of the membrane and a frame of the bipolar plate; and an electrolyte channel between the membrane frame assembly and the bipolar plate frame assembly delineated by channel ridges of the frame of the membrane frame assembly and channel ridges of the bipolar plate frame assembly, and wherein the electrolyte channel is positioned adjacent to the thermal weld in a plane perpendicular to a stacking direction of the cell. In this way, a strength and strain tolerance of the power module may be increased when compared to frames of an electrode cell affixed by adhesive. Further the power module may be quality checked immediately after welding. Additionally, the electrode cell may further include a single bipolar plate, a single positive electrode, a single mesh spacer, and a single membrane, thereby reducing a number of parts included when compared to an electrode cell including multiples of each.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system including a redox flow battery cell.

FIG. 2A shows a first perspective view of a welded power module.

FIG. 2B shows a side view of the welded power module.

FIG. 2C shows a second perspective view of the welded power module.

FIG. 3 shows an exploded view of the welded power module.

FIG. 4A shows a first side of a positive endplate of the welded power module.

FIG. 4B shows a second side of the positive endplate.

FIG. 4C shows a close view of an edge and the second side of the positive endplate.

FIG. 5A shows a first side of a negative endplate of the welded power module.

FIG. 5B shows a second side of the negative endplate of the welded power module.

FIG. 5C shows a close view of an edge and the second side of the negative endplate.

FIG. 6A shows a view of a membrane frame assembly of the welded power module.

FIG. 6B shows a close view of the membrane frame assembly.

FIG. 7A shows a view of a first side of bipolar plate frame assembly of the welded power module.

FIG. 7B shows a close view of the second side of the bipolar plate frame assembly.

FIG. 8A shows an edge view of the membrane frame assembly welded to the bipolar plate frame assembly.

FIG. 8B shows a close view of a portion of FIG. 8A.

FIG. 9A shows an exploded view of an electrode cell.

FIG. 9B shows a first edge view of the electrode cell.

FIG. 9C shows a second edge view of the electrode cell.

FIG. 10A shows a view of a current collector of the welded power module.

FIG. 10B shows a view of the current collector before welding.

FIG. 10C shows a view of the current collector after welding.

### DETAILED DESCRIPTION

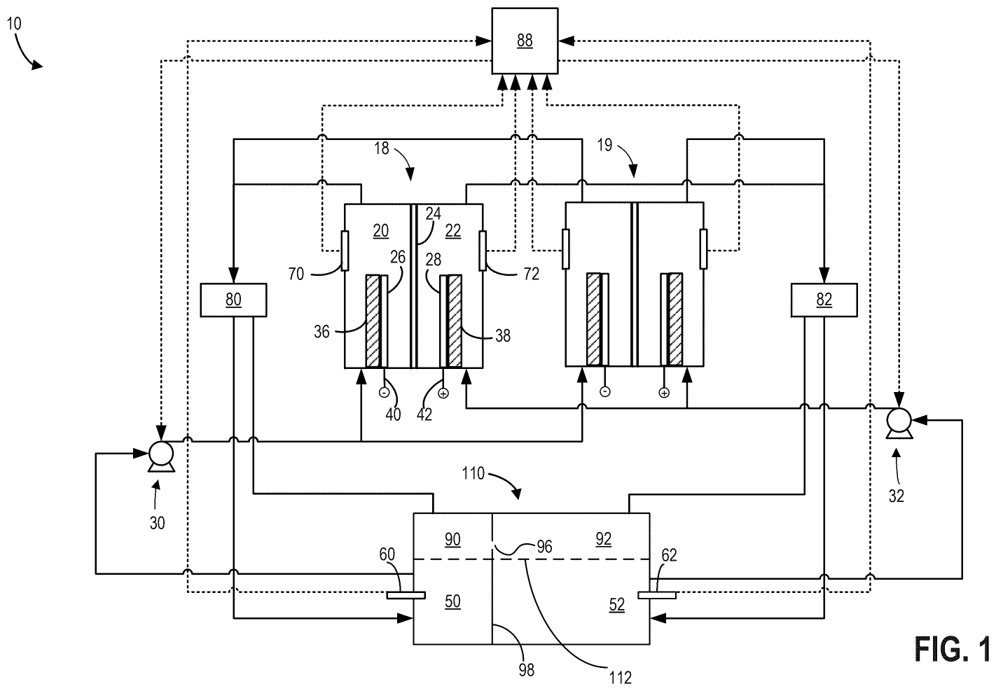

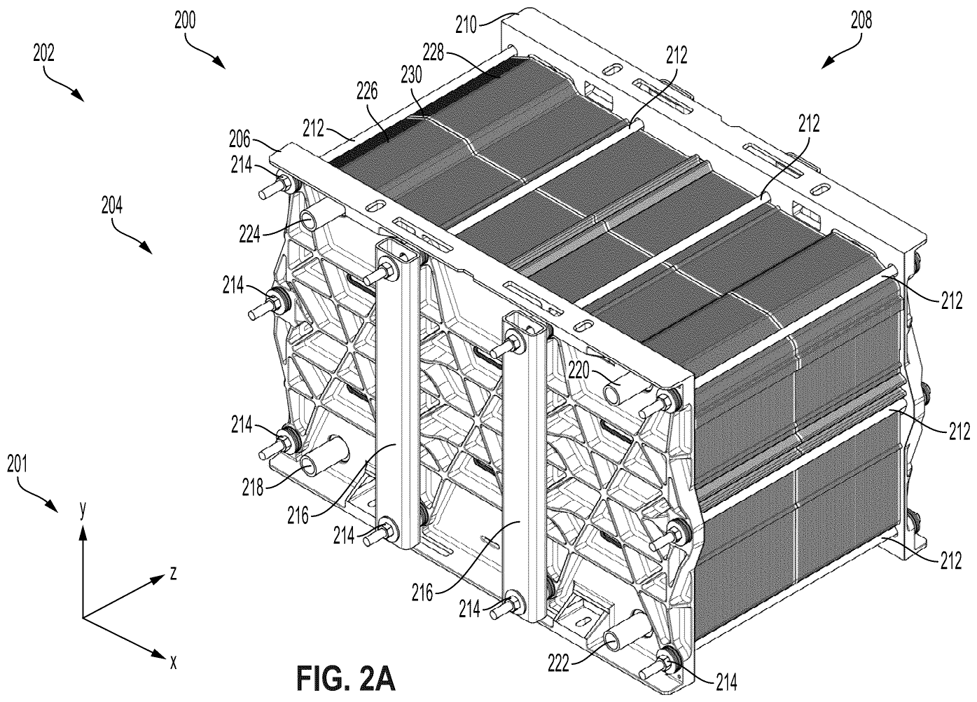

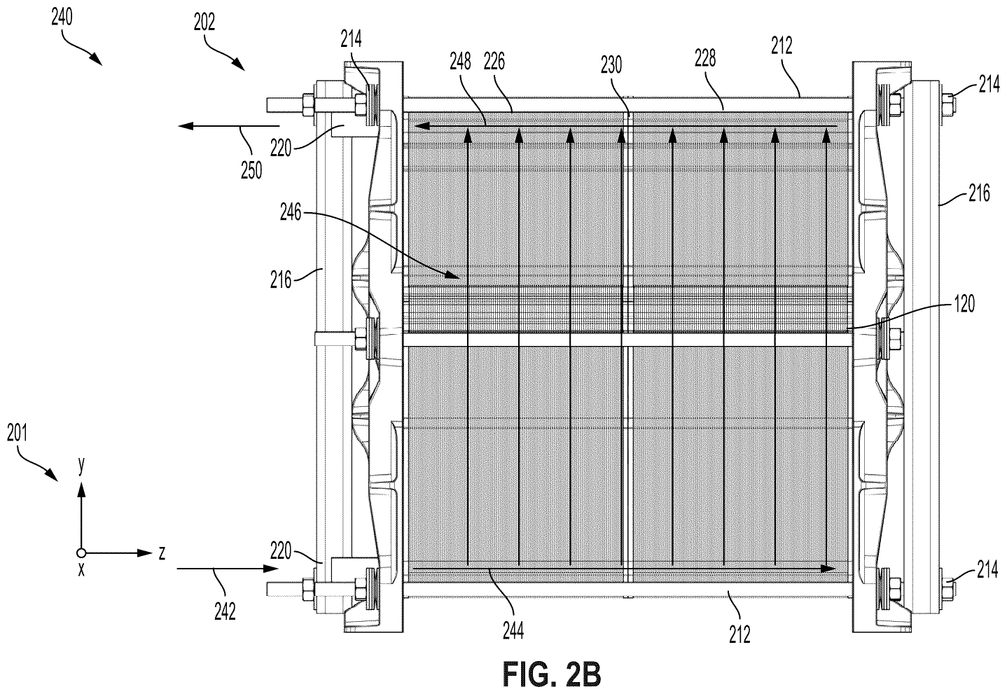

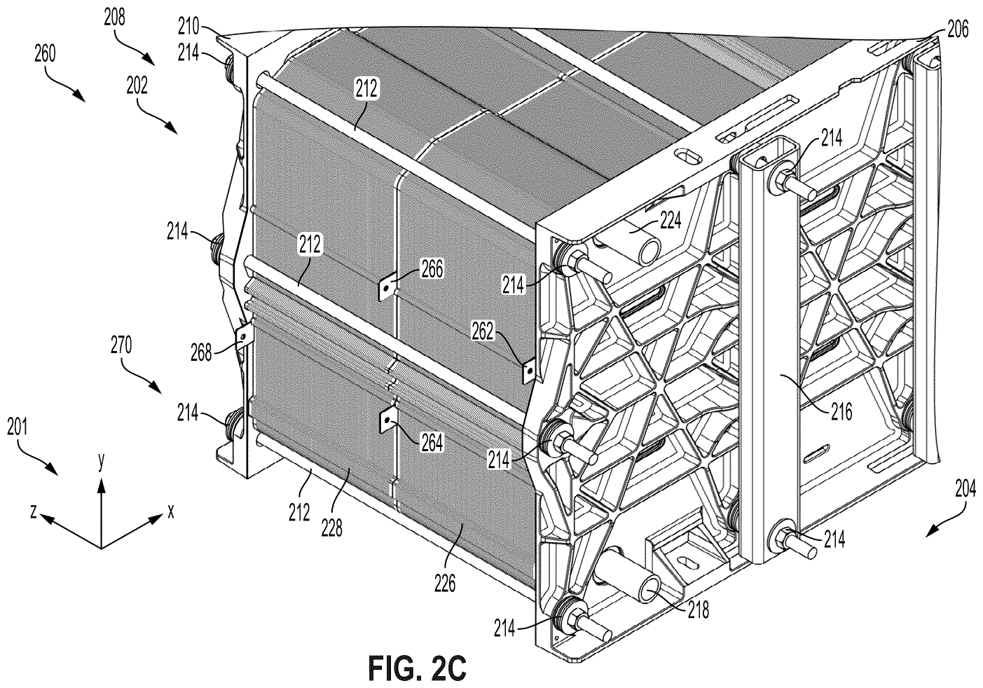

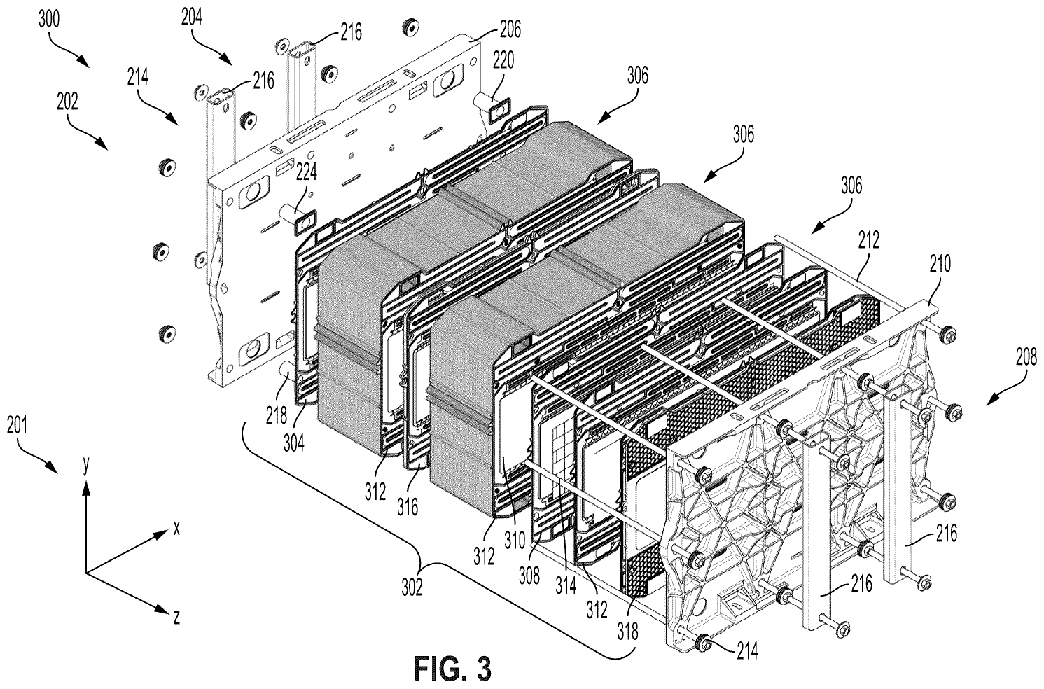

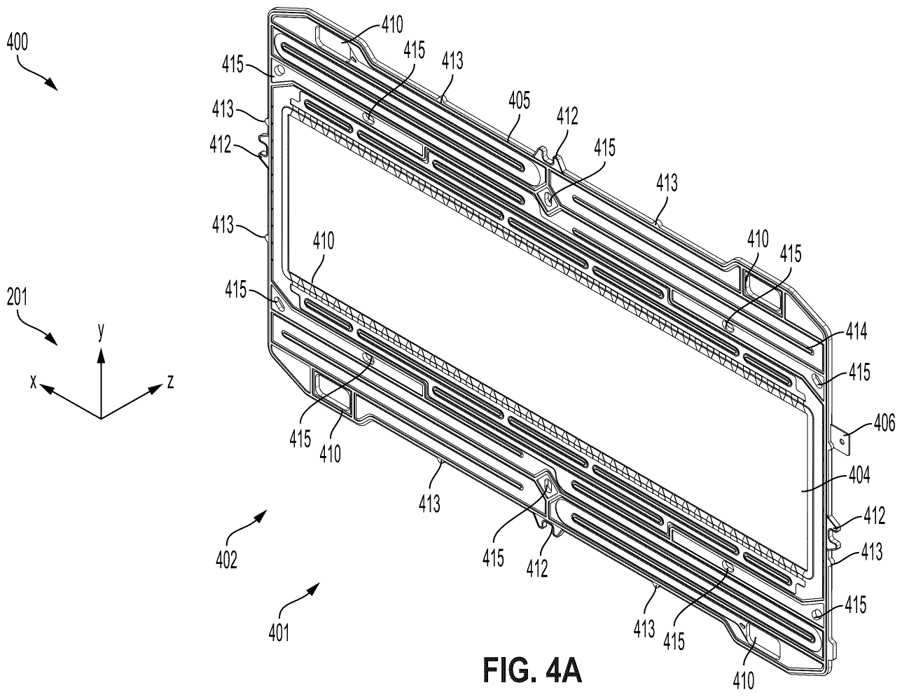

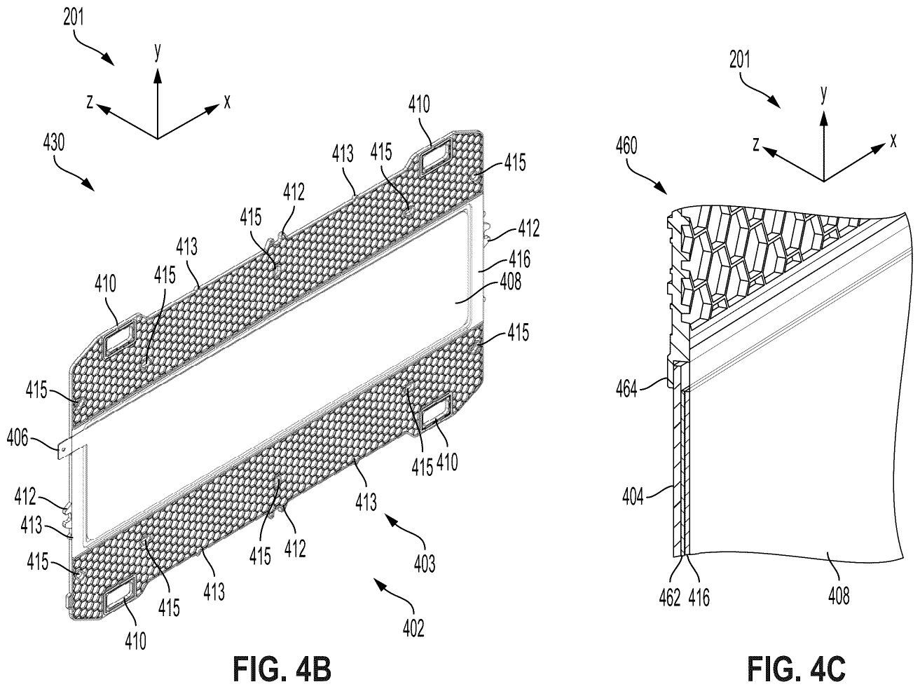

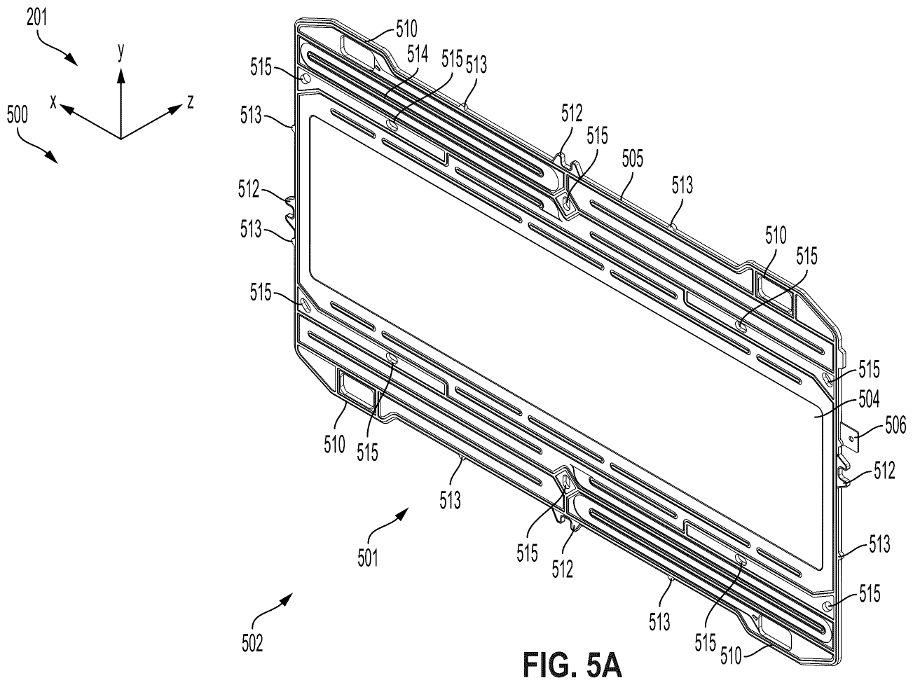

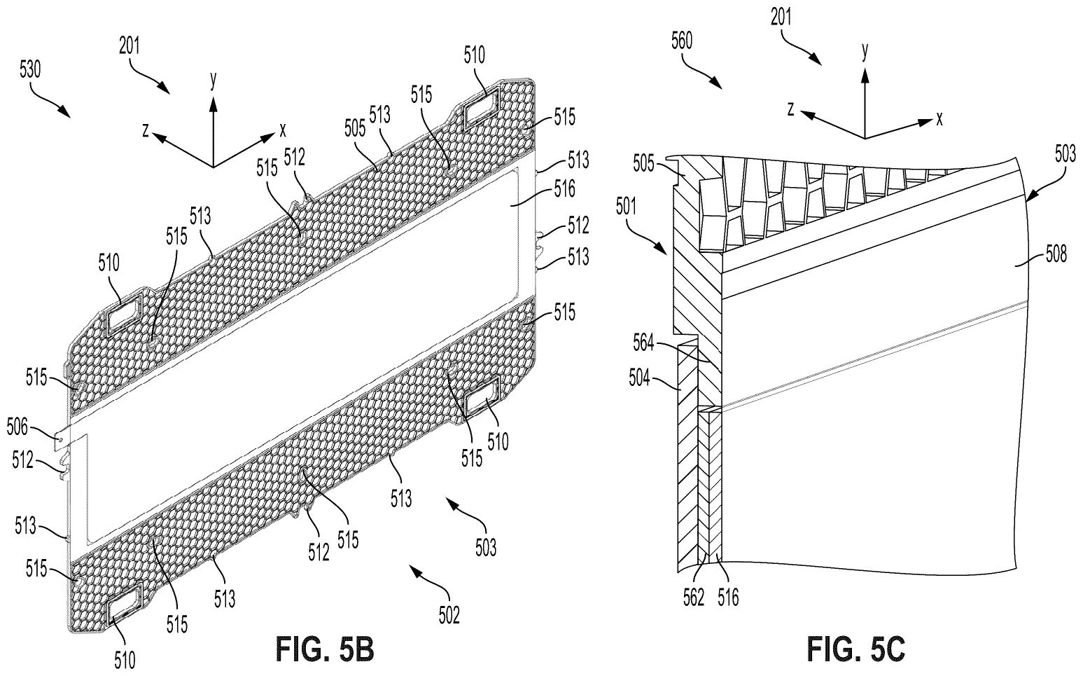

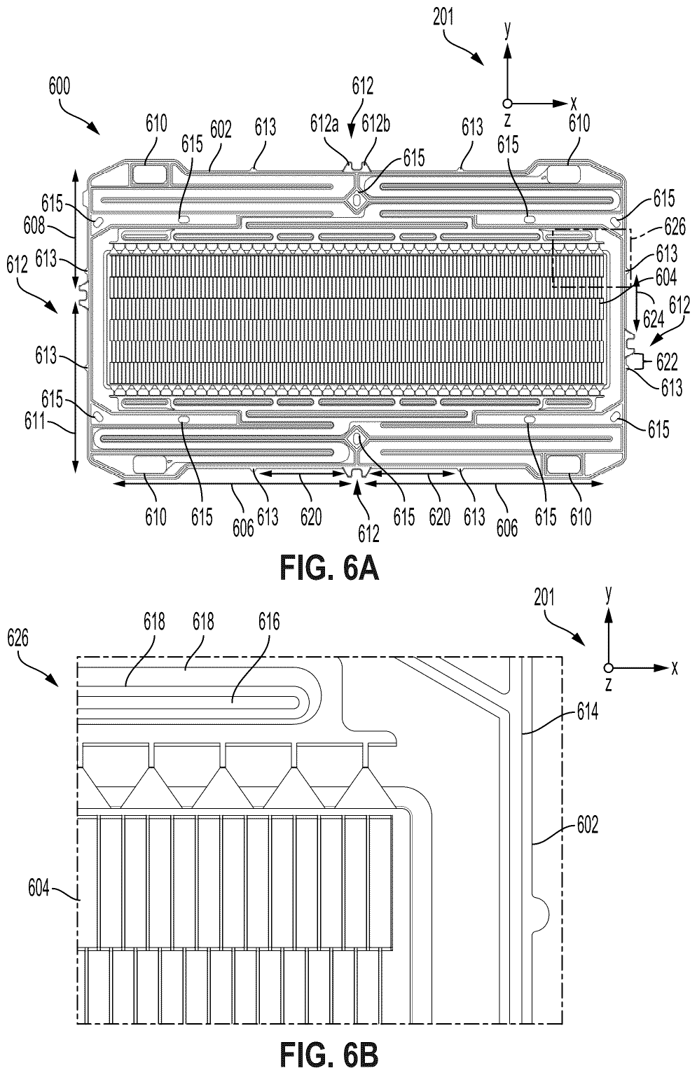

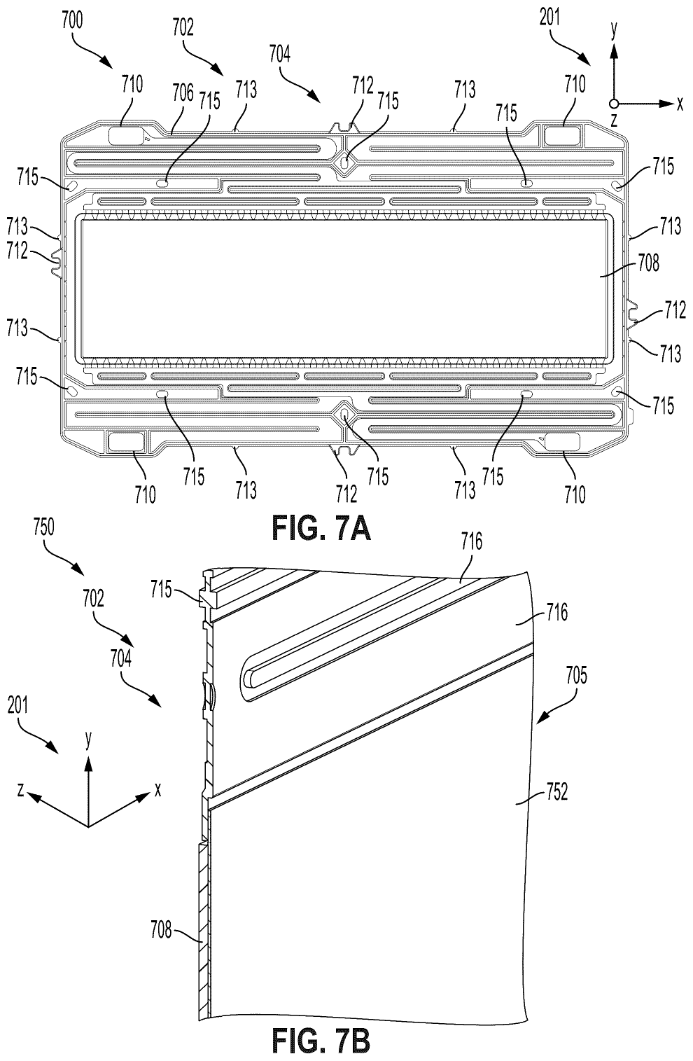

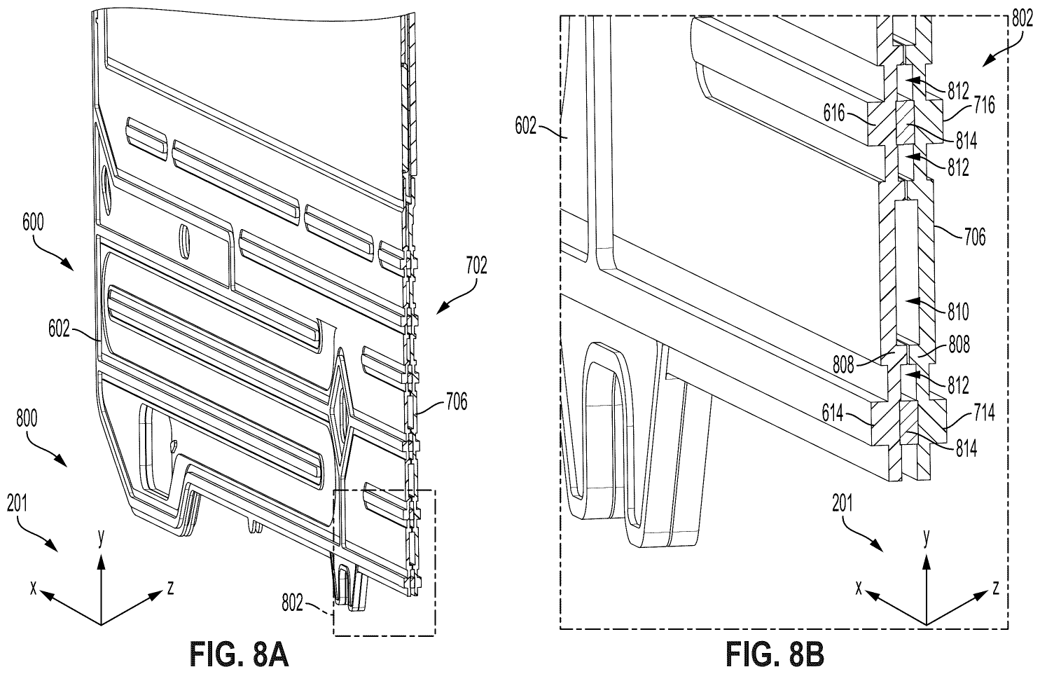

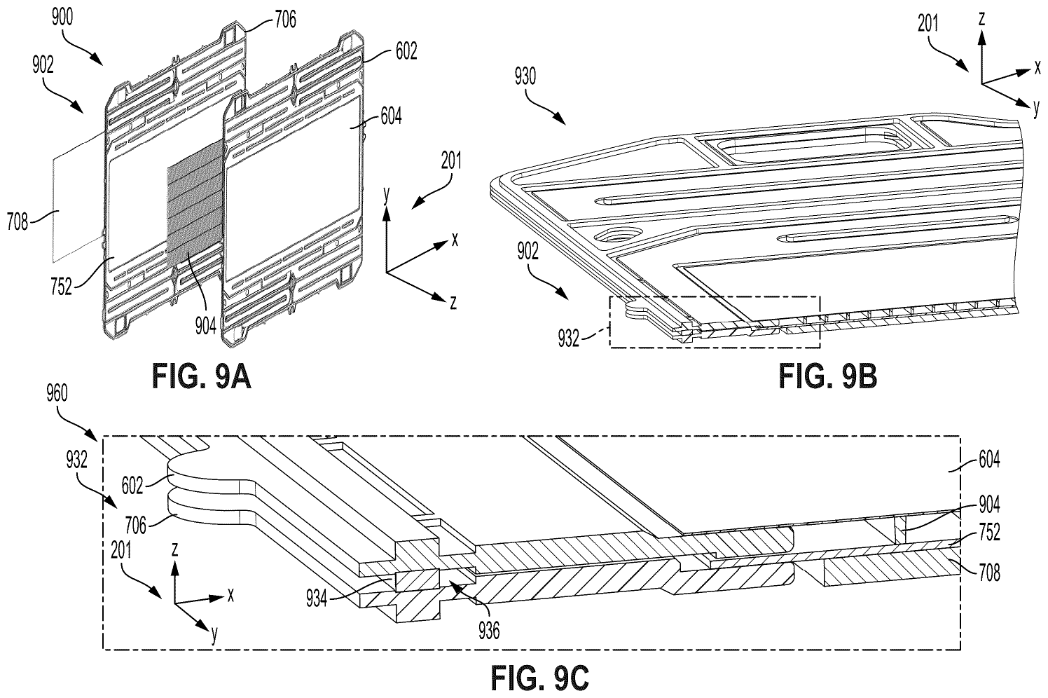

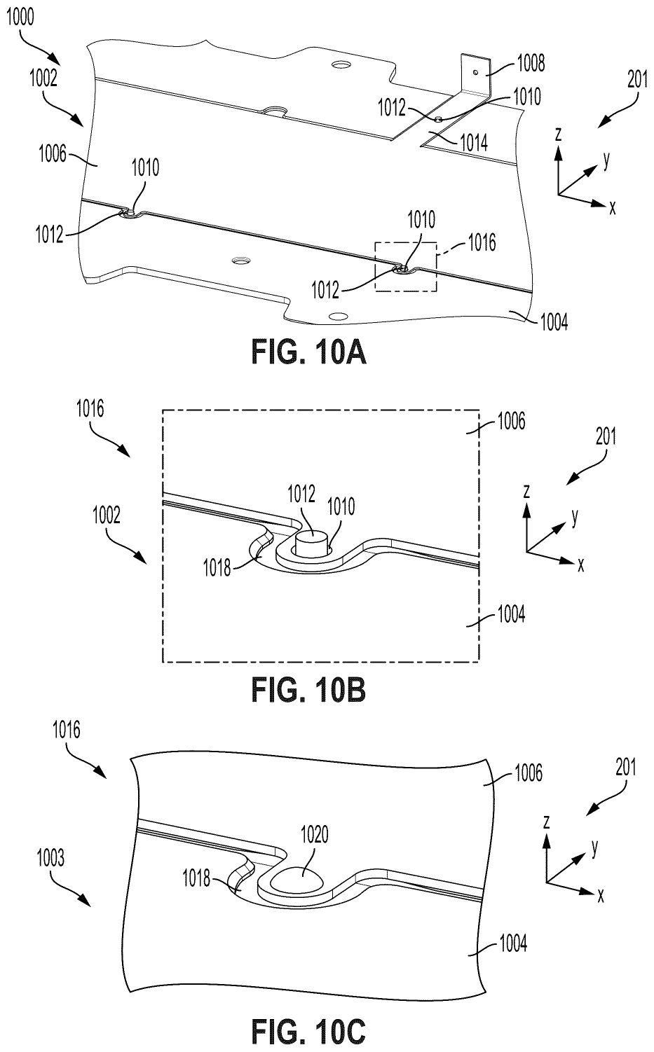

Systems and methods for manufacturing a thermally welded power module are described herein, as well as components thereof. Herein, a thermal weld may be a weld formed by thermally softening parts being mated together. The thermal weld may have a particular structure generated by the thermal welding operation that differentiates the weld structurally from other welds, such bead welds. Further, the thermal weld may be performed by hot plate welding, IR welding, or other appropriate thermally welding processes. Additionally, herein, the thermal weld may also additionally or alternatively include a weld formed by softening parts being mated together by using a chemical reagent or combination of chemical reagents. The power module may include a stack of a plurality of electrode cells included in a redox flow battery system. An example of a redox flow battery system including two redox flow battery (e.g., electrode) cells is shown in FIG. 1. To scale power output of the redox flow battery system, a plurality of redox flow battery cells may be stacked in a power module. An exemplary embodiment of a power module is shown in FIGS. 2A-3. Each redox flow battery cell may include a plurality of plates. The plates may be configured to be welded together to seal electrolyte within the power module. The power module may include a negative endplate, a positive endplate, a membrane frame assembly, and a bipolar plate frame assembly. An example of the positive endplate is shown in FIGS. 4A-4C. An example of the negative endplate is shown in FIGS. 5A-5C. An example of the membrane frame plate assembly is shown in FIGS. 6A-6B. An example of the bipolar plate frame assembly is shown in FIGS. 7A-B. To form a sealed redox flow battery cell, the membrane frame plate assembly may be thermally welded to the bipolar plate frame assembly. In this way the curing time and lack of strength and tolerance associated with application of adhesive is avoided. An example of a thermal weld at an interface between the membrane frame assembly and the bipolar plate frame assembly is shown in FIGS. 8A-8B. The membrane frame assembly, bipolar plate frame assembly along with a single mesh spacer, and a single positive electrode may comprise an electrode cell unit. An exploded view of the electrode cell unit as well as edge views of the assembled electrode cell unit are shown in FIGS. 9A-9C. The current collector is included in the negative endplate and positive endplate of the power module to provide electrical contact for current to flow into and out of the power module. A dome formed by a heated dome tool may be used to secure the current collector to the frame as shown in FIGS. 10A-10C.

As shown in FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal (Fe⁰) onto the negative electrode 26 during battery charge, and Fe⁰ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in equations (1) and (2), wherein the forward reactions (left to right) indicate electrochemical reactions during battery charge, while the reverse reactions (right to left) indicate electrochemical reactions during battery discharge:

$$\begin{matrix}{Fe}^{2 +} + 2 {e}^{-} ↔ {Fe}^{0} & - 0.44 V & ( negative electrode )\end{matrix} \qquad ( 1 )$$

$$\begin{matrix}{Fe}^{2 +} ↔ 2 {Fe}^{3 +} + 2 {e}^{-} & + 0.77 V & ( positive electrode )\end{matrix} \qquad ( 2 )$$

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolving back into the electrolyte. An equilibrium potential of the above reaction is −0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe³⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCl), manganese (II) chloride (MnCl₂), and boric acid (H₃BO₃). The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110. The redox flow battery cell 18 may include the negative electrode compartment 20, separator 24, and positive electrode compartment 22. The separator 24 may include an electrically insulating ionic conducting barrier which prevents bulk mixing of the positive electrolyte and the negative electrolyte while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may include electroactive materials. In some examples, multiple redox flow battery cells 18 may be combined in series or in parallel to generate a higher voltage or electric current in the redox flow battery system 10. Multiple redox flow battery cells 18 may be included in a power module, such as the power module described below with respect to FIGS. 2A-10C.

As an example, the redox flow battery system 10 is depicted in FIG. 1 with the first battery cell 18 as well as a second battery cell 19, similarly configured to the first battery cell 18. As such, all components and processes described herein for the first battery cell 18 may be similarly found in the second battery cell 19.

The first battery cell 18 may be included in a first cell stack and the second battery cell 19 may be included in a second cell stack. The first and second cells may be fluidly coupled or not fluidly coupled to one another but are each fluidly coupled to the electrolyte storage tank 110 and rebalancing reactors 80, 82. For example, each of the first and second battery cells 18, 19 may be connected to negative and positive electrolyte pumps 30 and 32 via common passages that branch to each of the first and second battery cells 18 and 19, as shown in FIG. 1. Similarly, the battery cells may each have passages that merge into common passages coupling the battery cells to the rebalancing reactors 80, 82.

Further illustrated in FIG. 1 are negative and positive electrolyte pumps 30 and 32, both used to pump electrolyte solution through the redox flow battery system 10. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

As illustrated in FIG. 1, the redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the electrodes 26 and 28. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions. FIG. 1 further illustrates a fill height 112 of the multi-chambered electrolyte storage tank 110, which may indicate a liquid level in each tank compartment. FIG. 1 also shows a gas head space 90 located above the fill height 112 of the negative electrolyte chamber 50, and a gas head space 92 located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ gas may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110 may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas head spaces 90 and 92, and may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52, and at least one inlet to each of the negative and positive electrolyte chambers 50 and 52. Furthermore, one or more outlet connections may be provided from the gas head spaces 90 and 92 for directing H₂ gas to rebalancing reactors or cells 80 and 82.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 and 52 may include one or more heaters. In the case where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together. For example, in response to an electrolyte temperature decreasing below a threshold temperature, the controller 88 may increase a power supplied to one or more heaters so that a heat flux to the electrolyte may be increased. The electrolyte temperature may be indicated by one or more temperature sensors mounted at the multi-chambered electrolyte storage tank 110, such as sensors 60 and 62. As examples, the one or more heaters may include coil type heaters or other immersion heaters immersed in the electrolyte fluid, or surface mantle type heaters that transfer heat conductively through the walls of the negative and positive electrolyte chambers 50 and 52 to heat the fluid therein. Other known types of tank heaters may be employed without departing from the scope of the present disclosure. Furthermore, the controller 88 may deactivate the one or more heaters in the negative and positive electrolyte chambers 50 and 52 in response to a liquid level decreasing below a solids fill threshold level. Said in another way, in some examples, the controller 88 may activate the one or more heaters in the negative and positive electrolyte chambers 50 and 52 only in response to a liquid level increasing above the solids fill threshold level. In this way, activating the one or more heaters without sufficient liquid in the negative and/or positive electrolyte chambers 50, 52 may be averted, thereby reducing a risk of overheating or burning out the heater(s).

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location. In one example, the end-use location may correspond to a location where the redox flow battery system 10 is to be installed and utilized for on-site energy storage. Said another way, the redox flow battery system 10 may be designed such that, once installed and hydrated at the end-use location, a position of the redox flow battery system 10 may become fixed, and the redox flow battery system 10 may no longer be deemed a portable, dry system. Thus, from a perspective of an end-user, the dry, portable redox flow battery system 10 may be delivered on-site, after which the redox flow battery system 10 may be installed, hydrated, and commissioned. Prior to hydration, the redox flow battery system 10 may be referred to as a dry, portable system, the redox flow battery system 10 being free of or without water and wet electrolyte. Once hydrated, the redox flow battery system 10 may be referred to as a wet, non-portable system, the redox flow battery system 10 including wet electrolyte.

Further illustrated in FIG. 1, electrolyte solutions primarily stored in the multi-chambered electrolyte storage tank 110 may be pumped via the negative and positive electrolyte pumps 30 and 32 throughout the redox flow battery system 10. Electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18.

The electrolyte rebalancing reactors 80 and 82 may be connected in line or in parallel with the recirculating flow paths of the electrolyte at the negative and positive sides of the redox flow battery cell 18, respectively, in the redox flow battery system 10. One or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the electrolyte rebalancing reactors 80 and 82 may be placed in a return flow path from the negative and positive electrode compartments 20 and 22 to the negative and positive electrolyte chambers 50 and 52, respectively.

The electrolyte rebalancing reactors 80 and 82 may serve to rebalance electrolyte charge imbalances in the redox flow battery system 10 occurring due to side reactions, ion crossover, and the like, as described herein. In one example, electrolyte rebalancing reactors 80 and 82 may include trickle bed reactors, where the H₂ gas and electrolyte may be contacted at catalyst surfaces in a packed bed for carrying out the electrolyte rebalancing reaction. In other examples, the rebalancing reactors 80 and 82 may include flow-through type reactors that are capable of contacting the H₂ gas and the electrolyte liquid and carrying out the electrolyte rebalancing reactions absent a packed catalyst bed.

During operation of the redox flow battery system 10, sensors and probes may monitor and control chemical properties of the electrolyte such as electrolyte pH, concentration, SOC, and the like. For example, as illustrated in FIG. 1, sensors 62 and 60 maybe be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties.

For example, a sensor may be positioned in an external acid tank (not shown) to monitor acid volume or pH of the external acid tank, wherein acid from the external acid tank may be supplied via an external pump (not shown) to the redox flow battery system 10 in order to reduce precipitate formation in the electrolytes. Additional external tanks and sensors may be installed for supplying other additives to the redox flow battery system 10. For example, various sensors including, temperature, conductivity, and level sensors of a field hydration system may transmit signals to the controller 88. Furthermore, the controller 88 may send signals to actuators such as valves and pumps of the field hydration system during hydration of the redox flow battery system 10. Sensor information may be transmitted to the controller 88 which may in turn actuate the pumps 30 and 32 to control electrolyte flow through the redox flow battery cell 18, or to perform other control functions, as an example. In this manner, the controller 88 may be responsive to one or a combination of sensors and probes.

The redox flow battery system 10 may further include a source of H₂ gas. In one example, the source of H₂ gas may include a separate dedicated hydrogen gas storage tank. In the example of FIG. 1, H₂ gas may be stored in and supplied from the integrated multi-chambered electrolyte storage tank 110. The integrated multi-chambered electrolyte storage tank 110 may supply additional H₂ gas to the positive electrolyte chamber 52 and the negative electrolyte chamber 50. The integrated multi-chambered electrolyte storage tank 110 may alternately supply additional H₂ gas to an inlet of the electrolyte rebalancing reactors 80 and 82. As an example, a mass flow meter or other flow controlling device (which may be controlled by the controller 88) may regulate flow of the H₂ gas from the integrated multi-chambered electrolyte storage tank 110. The integrated multi-chambered electrolyte storage tank 110 may supplement the H₂ gas generated in the redox flow battery system 10. For example, when gas leaks are detected in the redox flow battery system 10 or when a reduction reaction rate is too low at low hydrogen partial pressure, the H₂ gas may be supplied from the integrated multi-chambered electrolyte storage tank 110 in order to rebalance the SOC of the electroactive materials in the positive electrolyte and the negative electrolyte. As an example, the controller 88 may supply the H₂ gas from the integrated multi-chambered electrolyte storage tank 110 in response to a measured change in pH or in response to a measured change in SOC of an electrolyte or an electroactive material.

For example, an increase in pH of the negative electrolyte chamber 50, or the negative electrode compartment 20, may indicate that H₂ gas is leaking from the redox flow battery system 10 and/or that the reaction rate is too slow with the available hydrogen partial pressure, and the controller 88, in response to the pH increase, may increase a supply of H₂ gas from the integrated multi-chambered electrolyte storage tank 110 to the redox flow battery system 10. As a further example, the controller 88 may supply H₂ gas from the integrated multi-chambered electrolyte storage tank 110 in response to a pH change, wherein the pH increases beyond a first threshold pH or decreases beyond a second threshold pH. In the case of an IFB, the controller 88 may supply additional H₂ gas to increase a rate of reduction of Fe³⁺ ions and a rate of production of protons, thereby reducing the pH of the positive electrolyte. Furthermore, the pH of the negative electrolyte may be lowered by hydrogen reduction of Fe³⁺ ions crossing over from the positive electrolyte to the negative electrolyte or by protons, generated at the positive side, crossing over to the negative electrolyte due to a proton concentration gradient and electrophoretic forces. In this manner, the pH of the negative electrolyte may be maintained within a stable region, while reducing the risk of precipitation of Fe³⁺ ions (crossing over from the positive electrode compartment 22) as Fe(OH)₃.

Other control schemes for controlling a supply rate of H₂ gas from the integrated multi-chambered electrolyte storage tank 110 responsive to a change in an electrolyte pH or to a change in an electrolyte SOC, detected by other sensors such as an oxygen-reduction potential (ORP) meter or an optical sensor, may be implemented. Further still, the change in pH or SOC triggering action of the controller 88 may be based on a rate of change or a change measured over a time period. The time period for the rate of change may be predetermined or adjusted based on time constants for the redox flow battery system 10. For example, the time period may be reduced if a recirculation rate is high, and local changes in concentration (e.g., due to side reactions or gas leaks) may quickly be measured since the time constants may be small.

The controller 88 may further execute control schemes based on an operating mode of the redox flow battery system 10. For example, the controller 88 may control charging and discharging of the redox flow battery cell 18 so as to cause iron preformation at the negative electrode 26 during system conditioning (where system conditioning may include an operating mode employed to optimize electrochemical performance of the redox flow battery system 10 outside of battery cycling). That is, during system conditioning, the controller 88 may adjust one or more operating conditions of the redox flow battery system 10 to plate iron metal on the negative electrode 26 to improve a battery charge capacity during subsequent battery cycling (thus, the iron metal may be preformed for battery cycling). The controller 88 may further execute electrolyte rebalancing as discussed above to rid the redox flow battery system 10 of excess hydrogen gas and reduce Fe³⁺ ion concentration. In this way, preforming iron at the negative electrode 26 and running electrolyte rebalancing during the system conditioning may increase an overall capacity of the redox flow battery cell 18 during battery cycling by mitigating iron plating loss. As used herein, battery cycling (also referred to as “charge cycling”) may include alternating between a charging mode and a discharging mode of the redox flow battery system 10.

It will be appreciated that all components apart from the sensors 60 and 62 and the integrated multi-chambered electrolyte storage tank 110 (and components included therein) may be considered as being included in a power module (such as power module 202 discussed below with respect to FIGS. 2A-3). As such, the redox flow battery system 10 may be described as including the power module fluidly coupled to the integrated multi-chambered electrolyte storage tank 110 and communicably coupled to the sensors 60 and 62. In some examples, each of the power module and the multi-chambered electrolyte storage tank 110 may be included in a single housing (not shown), such that the redox flow battery system 10 may be contained as a single unit in a single location. It will further be appreciated the positive electrolyte, the negative electrolyte, the sensors 60 and 62, the electrolyte rebalancing reactors 80 and 82, and the integrated multi-chambered electrolyte storage tank 110 (and components included therein) may be considered as being included in an electrolyte subsystem. As such, the electrolyte subsystem may supply one or more electrolytes to the redox flow battery cell 18 (and components included therein).

Referring now to FIG. 2A-2C, perspective and side views of an exemplary embodiment of a power module 202 are shown. An exploded view of power module 202 is shown in FIG. 3. A set of axes 201 is shown for comparison between views shown in FIGS. 2A-3 as well as FIGS. 4A-10C. A z-axis may be parallel with a longitudinal direction of the power module and may also be parallel with a stacking direction of the cells and plates comprising the power module. A y-axis and an x-axis may be perpendicular the z-axis. The y-axis may be parallel to a vertical direction of the power module and the x-axis may be parallel to a horizontal direction of the power module. Further, the y-axis and x-axis may define a plane perpendicular to the stacking direction.

Turning to FIG. 2A, a first perspective view 200 of a redox flow battery power module 202 (e.g., power module 202) is shown. Looking along the stacking direction of power module 202, the power module 202 may be bracketed at first end 204 by a first pressure plate 206 and at a second end 208 by a second pressure plate 210. A plurality of bolts 212 may physically couple first pressure plate 206 to second pressure plate 210. A plurality of washers and/or springs 214 or similar hardware may be affixed to each of the plurality of bolts at the first end 204 and the second end 208. In this way, first pressure plate 206 and second pressure plate 210 may be secured on either side of the power module 202. In some examples, one or more leaf springs 216 may extend vertically (e.g., parallel to the y-axis) along first pressure plate 206 and second pressure plate 210. A top portion and bottom portion of the leaf spring (e.g., with respect to the y-axis) may include a hole through which one of the plurality of bolts 212 is passed and secured against the pressure plates by one of the plurality of washers and/or springs 214. Leaf springs 216 may help to evenly spread a compression load of the washers and/or springs 214 against first pressure plate 206 and second pressure plate 210 and help reduce deflection of first pressure plate 206 and second pressure plate 210.

A first side of power module 202 may include a positive electrolyte inlet 218, a positive electrolyte outlet 220, a negative electrolyte inlet 222, and a negative electrolyte outlet 224. In an exemplary embodiment, positive electrolyte inlet 218 and negative electrolyte inlet 222 may each be positioned at a bottom end (e.g., with respect to the y-axis) of first pressure plate 206 while positive electrolyte outlet 220 and negative electrolyte outlet 224 are positioned opposite negative electrolyte inlet 222 and positive electrolyte inlet 218 along the y-axis at a top end of first pressure plate 206. Additionally, negative electrolyte inlet 222 and negative electrolyte outlet 224 may be positioned at opposite edges of first pressure plate 206 with respect to the x-axis and positive electrolyte inlet 218 and positive electrolyte outlet 220 may be positioned at opposite edges of first pressure plate 206. Said another way negative electrolyte outlet 224 is positioned on a common vertical axis with positive electrolyte inlet 218 and positive electrolyte outlet 220 is positioned on a common vertical axis with negative electrolyte inlet 222.

In an exemplary embodiment, power module 202 may include a first substack 226 and a second substack 228. A separator 230 may be positioned between first substack 226 and second substack 228 in the stacking direction. Separator 230 may prevent direct physical contact between first substack 226 and second substack 228. In alternate embodiments, power module 202 may include a different number of substacks without departing from a scope of the disclosure. Components of the first substack 226 and second substack 228 are described further review with respect to the exploded view of FIG. 3.

Turing now to FIG. 2B, a side view 240 of power module 202 is shown. Looking at side view 240, a flow path of electrolyte through power module 202 is shown. The electrolyte shown in the side view may be positive electrolyte or negative electrolyte. Electrolyte may enter power module 202 through an electrolyte inlet such as negative electrolyte inlet 222 or positive electrolyte inlet 218 as shown by arrow 242. After entering power module 202, electrolyte may flow in the stacking direction between each of the cells of first substack 226 and second substack 228 as well as towards an opposite vertical end of power module 202, as shown by arrow 244 moving in the x-y plane through electrode cells as shown by arrows 246. At the opposite vertical end of power module 202 electrolyte may flow back through first substack 226 and second substack 228 as shown by arrow 248, and exit power module 202 through an electrolyte outlet, such as negative electrolyte outlet 224 or positive electrolyte outlet 220 as shown by arrow 250. Electrolyte may be confined within power module 202 within channels between welded plate frames of the power module as described further below with respect to FIGS. 8A-9C. In this way, electrolyte may enter and exit power module 202 through electrolyte inlets and outlets and not through vertical or horizontal sides of first substack 226 and second substack 228.

Turning now to FIG. 2C, a second perspective view 260 of power module 202 is shown. Second perspective view 260 may be looking at a side of power module 202 from an opposite direction along the x-axis than first perspective view 200. Second perspective view 260 may show a positive tab terminal 262 of first substack 226, a negative tab terminal 264 of first substack 226, a positive tab terminal 266 of second substack 228, and a negative tab terminal 268 of second substack 228, collectively referred to as terminals 270. Power module 202 may include more or less terminals depending on a number of substacks. Each of terminals 270 may protrude from a same side of power module 202. Positive and negative terminals may be offset vertically. Positioning each of terminals 270 on the same side of power module 202 may simplify integration and maintenance of multiple power modules as compared to multiple power modules including terminals positioned on opposite horizontal or vertical sides of each power module.

Turning now to FIG. 3, an exploded view 300 of power module 202 is shown. An interior of power module 202 may refer to a region denoted by bracket 302 positioned between first pressure plate 206 and second pressure plate 210.

A positive endplate 304 of first substack 226 may be positioned in direct face sharing contact with an interior side of first pressure plate 206. A negative endplate of the first substack 226 may be opposite positive endplate 304 along the stacking direction. A plurality of cells 306 may be positioned between positive endplate 304 and the negative endplate along the stacking direction. Cells 306 may include, in a stacking order, a membrane frame assembly 308, a positive felt electrode 310, a bipolar plate frame assembly 312, and a negative electrode spacer 314. Each of cells 306 may be thermally welded a neighboring electrode cell or to the positive or negative endplate. Additionally, the membrane frame assembly 308 may be thermally welded to the adjacent bipolar plate frame assembly 312.

A positive endplate 316 of second substack 228 may be positioned in direct face sharing contact with the negative endplate of first substack 226. Like first substack 226, second substack 228 may include a plurality of cells 306 positioned between positive endplate 316 and a negative endplate 318. Negative endplate 318 of second substack 228 may be in direct face sharing contact with an interior side of second pressure plate 210.

First substack 226 and second substack 228 may each include a number of cells 306. In one example a number of cells in each substack may be equivalent. In some examples each of first substack 226 and second substack 228 may include 50 cells.

Each of the positive endplates, negative endplates, membrane frame assemblies, and bipolar plate frame assemblies may be formed of a thermoplastic material. Further the positive endplates, negative endplates membrane frame assemblies, and bipolar plate frame assemblies may each be formed of substantially (e.g., within 5%) the same thermoplastic materials. In one example, the thermoplastic material may be polypropylene. Additionally or alternatively, the thermoplastic may include fillers configured to enhance a strength of the thermoplastic. For example, the thermoplastic may include glass fillers. Further the thermoplastic may by polypropylene including glass fillers. The positive endplates, negative endplates, membrane frame assemblies and bipolar plate frame assemblies may have substantially the same elastic modulus and substantially a same coefficient of thermal expansion (CTE). In this way, a robust thermal weld may be formed between any of the above mentioned components.

Features of positive endplates are described further below with respect to FIGS. 4A-4C. FIG. 4A shows a view 400 of a first side 401 of positive endplate 402 while FIG. 4B shows a second side 403 of positive endplate 402. Positive endplate 402 may be equivalent to positive endplate 304 of first substack 226 or equivalent to positive endplate 316 of second substack 228. The first side 401 may be opposite the second side shown 403 in the stacking direction. The first side 401 may be a side in direct face sharing contact with a membrane frame assembly of the cells (e.g., cells 306). The second side 403 may be the side in direct face sharing contact with the first pressure plate 206 (for the example of positive endplate 304) or in direct face sharing contact with the negative endplate of the adjacent substack (for the example of positive endplate 316).

Positive endplate 402 may include a frame 405 and a monopolar plate 404 positioned on the first side 401 of positive endplate 402. Monopolar plate 404 may be a single continuous plate circumferentially surrounded by frame 405. By forming monopolar plate 404 as a single continuous plate instead of multiple monopolar plates, manufacturing is simplified by reducing a total number of pieces. Additionally, in examples with multiple plates, the positive endplate includes additional, nonconductive frame material to separate the multiple monoplates, thereby decreasing a total active area for a positive endplate having the same dimensions. Monopolar plate 404 may be directly fixedly coupled to frame 405 by a thermal weld.

First side 401 of frame 405 may further include a weld rib 414. Weld rib 414 may be configured to be mated to and form a thermal weld with a corresponding weld rib of an adjacent membrane frame plate assembly. Configuration of weld rib 414 is discussed further below with respect to FIGS. 8A-B.

Frame 405 may further include four inlet/outlet (IO) openings 410 positioned two each at top and bottom horizontal edges (e.g., edges parallel to horizontal x-axis) of frame 405. Positions of IO openings 410 may be in line with positions of electrolyte inlets and outlets when positive endplate 402 is aligned within power module 202. IO openings 410 may align with corresponding openings of an adjacent membrane frame assembly, thereby forming a manifold distributing electrolyte throughout the stack. Increasing an area of IO openings 410 may more evenly distribute electrolyte between cells of the power module. In some examples, IO openings 410 may be shaped as a rectangle having rounded corners. A circular area (e.g., area in the x-y plane) of IO opening 410 may be selected based a desired flow rate. For a selected flow rate of electrolyte, a larger selected IO opening circular area may have increased flow distribution of the electrolyte. Additionally, increasing a circular area of IO openings 410 may reduce a pressure drop across multiple fluidly coupled stacks (e.g., greater than two substacks). As one example a circular area of openings 410 may bin a range of 5.07 cm² to 182.41 cm².

Frame 405 may further include a plurality of slot openings 415. The plurality of slot openings 415 may be positioned vertically in frame 405 between monopolar plate 404 between IO openings 410 and monopolar plate 404. The plurality of slot openings 415 may be distributed horizontally across frame 405. As one example, a quantity of the plurality of openings 415 may be an even number and frame 405 may include an equivalent number of openings positioned above and below monopolar plate 404 with respect to the vertical axis. Further a quantity of the plurality of slot openings 415 may be ten. The plurality of slot openings 415 may be configured as handling points for automated assembly of the power module. Further, the plurality of slot openings 415 may be configured as hold down points for an automated welding system, configured to automatically thermally weld monopolar plate 404 to frame 405 and to thermally weld frame 405 to an adjacent frame (e.g., membrane frame 602). Additionally or alternatively, plurality of slot openings 415 may aligned with a plurality of slot openings in the power module and may be configured to receive a bolt of a leaf spring system.

Frame 405 includes U-shaped protrusions 412. As one example, frame 405 may include four U-shaped protrusions, each protruding from one of four edges of frame 405. The U-shaped protrusions may be configured to align frame 405 with an adjacent frame. Frame 405 may further include semicircle protrusions 413. Semicircle protrusions 413 may also protrude from each of the four edges of frame 405. As one example, each edge may include two semicircle protrusions 413, one each positioned on either side a U-shaped protrusion 412. Semicircle protrusions 413 may also be configured to align frame 405 with the adjacent frame and to prevent misalignment or upside down and/or backwards placement of frame 405 within the power module. U-shaped protrusions 412 and semicircle protrusions are 413 discussed further below with respect to FIG. 6A.

Looking at FIG. 4B, it shows a view 430 of second side 403, a positive current collector 416 is positioned between monopolar plate 404 and a polymer insulating layer 408. Positive current collector 416 may be an electrically conductive material compatible with the battery environment. As one example, the polymer insulating layer may be formed of polyethylene terephthalate (PET). A tab terminal 406 may be formed continuously from positive current collector 416 and protrude from a side of positive endplate 402 in a horizontal direction. Tab terminal 406 may be similar to positive tab terminal 266 or positive tab terminal 262 of FIG. 2C. By positioning tab terminal 406 protruding in the horizontal direction (e.g., over a vertical edge of positive endplate 402), distance of overlay between tab terminal 406 and positive endplate 402 and a total amount of material demanded for positive current collector 416 are minimized.

A cross sectional view 460 of positive endplate 402 is shown in FIG. 4C. A circumference of monopolar plate 404 may be in direct face sharing contact with first side 401 and may be affixed by a thermal weld to positive endplate 402. Further, first side 401 may include a lip 464 extending from first side 401 and forming an indent when looking at second side 403. Lip 464 may circumferentially surround monopolar plate 404, and the weld may circumferentially surround the monopolar plate 404, affixing monopolar plate 404 to lip 464. A foil 462 may be positioned between current collector 416 and monopolar plate 404. Foil 462 may be a soft, deformable, electrically conductive material. In this way foil 462 may be a compliant layer between monopolar plate 404 and current collector 416. In this way, foil 462 may reduce a contact resistance between monopolar plate 404 and current collector 416. In one example, foil 462 may be a carbon foil. A circumference of polymer insulating layer 408 may be affixed to second side 403 of positive endplate 402 by a weld. The weld may circumferentially surround the polymer insulating layer. In this way, current collector 416 may be sandwiched between the foil 462 and the polymer insulating layer 408.

Features of negative endplates are described further below with respect to FIGS. 5A-5C. FIG. 5A shows a perspective view 500 of first side 501 of negative endplate 502 while FIG. 5B shows a perspective view 530 of second side 503 of negative endplate 502. Negative endplate 502 may be equivalent the negative endplate of first substack 226 or equivalent to negative endplate 318 of second substack 228. The first side 501 may be opposite the second side 503 in the stacking direction. The first side 501 may be a side in direct face sharing contact with a bipolar plate frame assembly of the cells (e.g., cells 306). The second side 403 may be the side in direct face sharing contact with the second pressure plate 210 (for the example of negative endplate 318) or in direct face sharing contact with the positive endplate of the adjacent substack (for the example the negative endplate of the first substack 226).

Features of negative endplate 502 may be similar to features of positive endplate 402. Negative endplate 502 may include a frame 505 circumferentially surrounding a single monopolar plate 504. Frame 505 may include IO openings 510 and slot openings 515, weld tongue 514, U shaped protrusions 512, and semicircle protrusions 513. The above mentioned features may each be formed and positioned similarly to the corresponding features of positive endplate 402. In this way, features of negative endplate 502 may align both vertically and horizontally with features of positive endplate 402 and with the additional frames of the stack. Said another way, the features of negative endplate 502 may be aligned with features of positive endplate 402 in a plane perpendicular to the stacking direction (e.g., the z-axis).

Further, negative endplate 502 may include a negative current collector 516 and a tab terminal 506. Negative current collector 516 and tab terminal 506 may be formed and positioned similarly to positive current collector 416 and tab terminal 406 of positive endplate 402. Tab terminal 506 may be similar to negative tab terminal 268 or negative tab terminal 264 of FIG. 2C. Tab terminal 506 may protrude horizontally from negative endplate 502 in the same direction as tab terminal 406. In this way tab terminal 406 and tab terminal 506 may both extend from the same side of the power module when assembled as shown in FIG. 2C.

FIG. 5C shows a cross sectional view 560 of negative endplate 502. Similar to positive endplate 402, The cross sectional view shows monopolar plate 504 in face sharing contact with a foil 562 and negative current collector 516 in face sharing contact with foil 562 and positioned between foil 562 and polymer insulating layer 508. Foil 562 and polymer insulating layer 508 may be similar to foil 462 and polymer insulating layer 408 of positive endplate 402. Negative endplate 502 may include a lip 564. Lip 564 may extend from second side 503 forming an indent when looking at first side 501 and single monopolar plate 504 may be positioned within the indent. A circumference of single monopolar plate 504 may be in face sharing contact with lip 464 and may be welded to lip 464. A circumference of polymer insulating layer 508 may be in face sharing contact with second side 503 and may be thermally welded to second side 503.

Turning now to FIGS. 6A-6B, an exemplary membrane frame assembly 600 is shown. Membrane frame assembly 600 may be similar to similar to membrane frame assembly 308 of FIG. 3 and may be positioned between positioned in direct face sharing contact with a bipolar plate frame assembly in an electrode cell, such as cells 306 of FIG. 3.

Membrane frame assembly 600 may include a frame 602 and a single membrane 604. A vertical height and horizontal length of the single membrane 604 may be substantially the same as the vertical height and horizontal length of single monopolar plate 404 of the positive endplate 402 and of single monopolar plate 504 of the negative endplate 502. Single membrane 604 may be circumferentially surrounded by frame 602 and may be affixed to frame 602 by a thermal weld.

Frame 602 of the membrane frame assembly 600 may be formed similarly to frame 405 of positive endplate 402 and frame 505 of negative endplate 502. Frame 602 includes IO openings 610, slot openings 615, U-shaped protrusions 612, and semicircle protrusions 613, each of which may be aligned in a plane perpendicular to the stacking direction (e.g., vertically and horizontally) with corresponding features of frames of the power module.

U-shaped protrusions, including U-shaped protrusions 612 may include a first curved arm 612a and a second curved arm 612b and an opening therebetween configured to receive an alignment rod. Each of the U-shaped protrusions 612 may be positioned between adjacent corners of frame 602. In some examples, a distance 606 to a first corner and the distance to the adjacent corner may be equivalent. Said another way, U-shaped protrusion 612 may be positioned equidistant between adjacent corners. U-shaped protrusions positioned on horizontal edges may be positioned differently than U-shaped protrusions on vertical edges. In this way, accidental 90° rotations of frame 602 may be avoided. In alternate examples a distance 608 to the first corner may be different from a distance 611 to the adjacent corner. In further examples, U-shaped protrusions on horizontal edges may both be equidistant from corners and may be aligned vertically with each other on frame 602. U-shaped protrusions on vertical edges may not be aligned horizontally.

Semicircle protrusions 613 may protrude from vertical and horizontal edges of a frame (e.g., membrane frame 602). As one example each edge of the frame may include two semicircle protrusions 613. Additionally or alternatively, the U-shaped protrusion 612 may be positioned between two semicircle protrusions 613. The U-shaped protrusion may be a first distance from a first semicircle protrusion in a first direction and a second distance from a second semicircle protrusion in a second direction. In some examples, the first distance and the second distance may be indicated by arrows 620 and may be equivalent distances. Further the first distance and second distance may be equivalent distances for U-shaped protrusions on horizontal edges of the frame. Additionally or alternatively, the first distance may be different than the second distance. For example, the first distance may be indicated by arrow 624 and may be longer than a second distance indicated by bracket 622. Further the first distance and second distance may be different for U-shaped protrusions on vertical edges of the frame. Additionally, the first distance and the second distance may be different for a first vertical side (e.g., a left side with respect to FIG. 6A) and a second vertical side (e.g., a right side with respect to FIG. 6A).

A portion of membrane frame assembly 600 denoted by box a 626 is shown in an enlarged view in FIG. 6B. A first side and second side (e.g., in the x-y plane) of frame 602 may include weld ribs protruding from the first side and second side in the stacking direction. Edge weld ribs 614 may circumferentially surround frame 602. Inner weld ribs 616 may be positioned vertically above and below single membrane 604. Inner weld ribs 616 may be adjacent to channel ribs 618. Features of channel ribs and weld ribs are described further below with respect to 8A through 9C.

Turning now to FIG. 7A-7B a side view 700 (FIG. 7A) and a cross sectional view 750 (FIG. 7B) of a bipolar plate frame assembly 702 are shown. Side view 700 shows a first side 704 of bipolar plate frame assembly 702. Bipolar plate frame assembly 702 may be similar to bipolar plate frame assembly 312 of FIGS. 4A-C and may be in face sharing contact with a membrane frame assembly forming an electrochemical cell (e.g., plurality of cells 306) of a power module. Bipolar plate frame assembly 702 may include a bipolar plate frame 706 and a single positive electrode 708. An area in the x-y plane of single positive electrode 708 may be equivalent to the area in the x-y plane of single membrane 604. Single positive electrode 708 may be formed of an electrically conductive felt material. As one example the electrically conductive felt may be formed of a carbonized polymer precursor. As one example, the carbonized precursor may be polyacrylonitrile.

Bipolar plate frame 706 may include features similar to the features of membrane frame assembly 600, frame 405 of positive endplate 402 and frame 505 of negative endplate 502. For example, bipolar plate frame 706 may include IO openings 710, slot openings 715, U-shaped protrusions 712, and semicircle protrusions 713. U-shaped protrusions 712 may further receive the alignment rod that is also received by U-shaped protrusions of membrane frame 600. In this way outer edges of membrane frame 600 may be aligned with outer edges of bipolar plate frame 706. Additionally, bipolar plate frame 706 may include edge weld ribs 714 and inner weld ribs 716. Edge weld ribs 714 and inner weld ribs 716 may be configured to be in face sharing contact with and thermally welded to edge weld ribs and inner weld ribs of membrane frame 602, thereby forming a thermal weld positioned between bipolar plate frame assembly 702 and membrane frame assembly 600.

Turning now to FIG. 7B, first side 704 and second side 705 of bipolar plate frame assembly 702 is shown. Second side 705 of bipolar plate frame assembly 702 may include a single bipolar plate 752. Single bipolar plate 752 may be circumferentially surround by bipolar plate frame 706. Further, single bipolar plate 752 may be directly affixed to bipolar plate frame 706 via a thermal weld. Single bipolar plate 752 may be in face sharing contact with single positive electrode 708. An area in the x-y plane of single bipolar plate 752 may be larger than the area in the x-y plane of single positive electrode 708.

Turning now to FIG. 8A, a cross sectional view 800 of membrane frame assembly 600 in face sharing contact with bipolar plate frame assembly 702 is shown. As described above, openings (e.g., IO openings and slot openings) of membrane frame 602 and bipolar plate frame 706 are aligned to be substantially fully overlapping in the plane perpendicular to the stacking direction, thereby forming continuous openings therebetween. Additionally, protrusions (e.g., U-shaped protrusions and semicircle protrusions) of membrane frame 602 and bipolar plate frame 706 are aligned and in direct face sharing contact. Aligning semicircle protrusions and U-shaped protrusions in this way may help ensure alignment and face sharing contact of edge weld ribs and channel weld ribs of adjacent frames as shown in more detail in FIG. 8B.

FIG. 8B shows an enlarged cross sectional view corresponding to an area denoted by box 802 of FIG. 8A. Where edge weld rib 614 of membrane frame 602 is in direct face sharing contact with corresponding edge weld rib 714 of bipolar plate frame 706 a thermal weld 814 may be present. During thermal welding heat may be used to temporarily soften a weld rib (e.g., edge weld rib and/or inner weld rib) of membrane frame 602 and a corresponding weld rib of bipolar plate frame 706, rendering the thermoplastic deformable. The two weld ribs may be pressed together while still deformable and subsequently cooled, thereby forming the thermal weld. In this way, a thermal weld such as thermal weld 814 includes material from the weld ribs of each of the frames being welded together. Thermal weld 814 is described further in the following paragraphs but the description is understood to apply to other thermal welds of the redox flow battery stack. In some examples, thermal welds may only be between formed weld ribs of adjacent frames, plates, and endplates of the redox flow battery stack.

For example, thermal weld 814 may include material from bipolar plate frame 706 and from membrane frame 602. Within thermal weld 814, material from bipolar plate frame 706 and from membrane frame 602 may be in direct physical contact. Direct physical contact may include intermixed and/or enmeshed material of the membrane frame 602 and bipolar plate frame 706 such that the direct physical contact is in three-dimensions. Thermal weld 814 may not include material other than material of the bipolar plate frame and membrane plate frame. For example, thermal weld 814 may not include adhesive. Additionally, thermal weld 814 may not include a weld bead.

Further, a height of thermal weld 814 in the stacking direction may be less than a combined height in the stacking direction of weld ribs of bipolar plate frame 706 and membrane frame 602. In this way, bipolar plate frame assembly 702 is affixed to membrane frame assembly 600 and adhesive is not present at an interface between bipolar plate frame assembly 702 and membrane frame assembly 600. Further interfaces between membrane frame assembly 600 and bipolar plate frame assembly 702 may be substantially free of adhesive. Similarly, positive endplate 402 and negative endplate 502 may be affixed to an adjacent membrane frame or bipolar plate frame by a thermal weld.

First sides of bipolar plate frame 706 and membrane frame 602 may include channel ridges 808. A height in the stacking direction of channel ridges 808 may be less than the height in the z-direction of weld ribs. After thermal welding, channel ridges 808 of each of the bipolar plate frame 706 and membrane frame 602 may be in face sharing contact, thereby delineating an electrolyte channel 810 therebetween. In some examples, a thermal weld may not be between channel ridges 808. Electrolyte channel 810 may carry positive electrolyte or negative electrolyte vertically through the power stack. Electrolyte channel 810 may be formed of corresponding channel grooves in membrane frame 602 and bipolar plate frame 706. A height in the stacking direction of electrolyte channel 810 may be a combined height of the grooves. Electrolyte channel 810 may be adjacent to thermal weld 814 in a plane perpendicular to a stacking direction of the cells. Additionally, a channel flash trap 812 may be a space between membrane frame 602 and bipolar plate frame 706 may be delineated by mated channel ridges 808 on one side and on the opposite side by thermal weld 814. Channel flash trap 812 may provide a buffer area for overflow material of the weld ribs to flow into while softened without impeding electrolyte flow through the electrolyte channels. Additionally, the channel flash trap 812 may provide a tolerance for vertical and/or horizontal offset between membrane frame assembly 600 and bipolar plate frame assembly 702 during thermal welding while still affixing bipolar plate frame 706 to membrane frame 602 and without positioning weld rib material within the electrolyte channel.

While FIGS. 8A-8B show thermal weld 814 between membrane frame assembly 600 and bipolar plate frame assembly 702, similar thermal welds may be between an endplate (either negative endplate or positive endplate) and an adjacent plate frame (either bipolar plate frame or membrane frame 602). Further a flash trap and an electrolyte channel may be similarly formed therebetween.

Turning now to FIG. 9A, an exploded view 900 of an electrode cell 902 is shown. Electrode cell 902 may be similar to cells 306 of FIG. 3. A power module may include a plurality of cells such as electrode cell 902 stacked in the z-direction. In a stacking order, the electrode cell may include single positive electrode 708, single bipolar plate 752 affixed to bipolar plate frame 706, a single mesh spacer 904, and single membrane 604 affixed to membrane frame 602. Single mesh spacer 904 may be used instead of multiple mesh spacers because of single bipolar plate 752 and single membrane 604. In this way, a total number of parts included in the power module may be reduced. Single mesh spacer 904 may be a rigid mesh and may include reinforcing ribs and cross-bracing configured to provide structural support and reduce unwanted flexion of electrode cell 902.

FIG. 9B shows a cross sectional view 930 of electrode cell 902. A close up view of the area denoted by box 932 is shown in cross sectional view 960 of FIG. 9C. As described above, single membrane 604 may be thermally welded to membrane frame 602 and single bipolar plate 752 may be thermally welded to bipolar plate frame 706. When stacked in electrode cell 902, membrane frame 602 may be in direct face sharing contact with a single bipolar plate 752. Similarly, bipolar plate frame 706 may be in direct face sharing contact with single membrane 604. A thermal weld may not present between membrane 602 and single bipolar plate 752 and there may not a thermal weld present between bipolar plate frame 706 and single membrane 604. Additionally, a thermal weld 934 may be present where edge weld ribs of membrane frame 602 and bipolar plate frame 706 are in face sharing contact. An edge flash trap 936 may form in a space between membrane frame 602 and bipolar plate delineated on at least one edge by thermal weld 934. In this way, material displaced during thermal welding may be displaced into edge flash trap 936 and not onto single membrane 604 or single bipolar plate 752. Further, edge flash trap 936 may also allow for tolerance of vertical and/or horizontal offset of membrane frame assembly 600 and bipolar plate frame assembly 702 during thermal welding.

Turning now to FIG. 10A, a perspective view 1000 of an unfastened endplate 1002 including an endplate frame 1004 and a current collector 1006 are shown before formation of fasteners. Endplate 1002 may be similar to positive endplate 402 or negative endplate 502 and current collector 1006 may be similar to positive current collector 416 of the positive endplate or negative current collector 516 of the negative endplate. A tab terminal 1008 may be formed continuously with current collector 1006 and may extend from current collector 1006 past an edge of endplate frame 1004.

Current collector 1006 may include one or more post holes 1010 and endplate frame 1004 may include one or more posts 1012 corresponding to positions of the one or more post holes. As one example, the one or more post holes 1010 may be positioned on semicircular protrusions from an edge of current collector 1006. As another example, one or more post holes may be positioned on a tongue 1014 of the current collector, the tongue 1014 joining tab terminal 1008 to current collector 1006. In some examples, current collector 1006 may include three post holes 1010 and three posts 1012. As one example, one post hole 1010 and corresponding post 1012 may be positioned on tongue 1014 and two post holes 1010 and corresponding posts 1012 may be positioned on semicircles protrusions from an edge of current collector 1006 positioned opposite tongue 1014 along the y-axis

A portion of unfastened endplate 1002 denoted by box 1016 is shown in greater detail in FIG. 10B. As seen in FIG. 10B, endplate frame 1004 may include a semicircle indent 1018 configured to receive the semicircle protrusion of current collector 1006. Post 1012 may protrude from endplate 1002 in the z-direction at a height above an edge of semicircle indent 1018.

Turning now to FIG. 10C it shows the same portion denoted by box 1016 of fastened endplate 1003. A domed heated tool may be applied to one or more posts 1012 to produce fastened endplate 1003 from unfastened endplate 1002. The domed heated tool may deform one or more posts 1012 from a post shape to a dome 1020. A diameter of dome 1020 may be greater than a diameter of one or more post holes 1010. In this way dome 1020 may be configured to securely fasten current collector 1006 to endplate frame 1004.

The thermally welded power module as described above with respect to FIGS. 2A-10C may be efficiently manufactured and tested, thereby forming a robust thermoplastic power module. The cooling time demanded before testing a thermal weld may be significantly shorter than the days demanded of drying time before testing when components of the power module are affixed by adhesive. Further, the thermal weld may be more robust than adhesive. Additionally, by using single active areas (e.g., bipolar plate, monoplolar plate, membrane, and positive electrode) and a single mesh, a total active area of a given may be increased and a number of parts of the power module may be decreased and manufacturing may be simplified.

The disclosure also provides support for a cell of a redox flow battery system, comprising: a membrane frame assembly, a bipolar plate frame assembly, a thermal weld positioned between the membrane frame assembly and the bipolar plate frame assembly, the thermal weld including material from a frame of the membrane frame assembly and a frame of the bipolar plate frame assembly, and an electrolyte channel between the membrane frame assembly and the bipolar plate frame assembly delineated by channel ridges of the frame of the membrane frame assembly and channel ridges of the frame of bipolar plate frame assembly, and wherein the electrolyte channel is positioned adjacent to the thermal weld in a plane perpendicular to a stacking direction of the cell. In a first example of the system, adhesive is not present at an interface between the membrane frame assembly and the bipolar plate frame assembly. In a second example of the system, optionally including the first example, the membrane frame assembly and the bipolar plate frame assembly are formed of substantially the same thermoplastic materials. In a third example of the system, optionally including one or both of the first and second examples, substantially the same thermoplastic materials have substantially the same coefficient of thermal expansion (CTE) and elastic modulus. In a fourth example of the system, optionally including one or more or each of the first through third examples, the frame of the membrane frame assembly and the frame of the bipolar plate frame assembly include U-shaped protrusions configured to receive an alignment rod to align the frame of the membrane frame assembly with the frame of the bipolar plate frame assembly. In a fifth example of the system, optionally including one or more or each of the first through fourth examples, the frame of the membrane frame assembly and the frame of the bipolar plate frame assembly include semicircle protrusions configured to align the frame of the membrane frame assembly with the frame of the bipolar plate frame assembly. In a sixth example of the system, optionally including one or more or each of the first through fifth examples, the cell further includes a channel flash trap between the membrane frame assembly and the bipolar plate frame assembly and delineated on one side by the thermal weld, the channel flash trap configured to receive overflow material from the thermal weld.

The disclosure also provides support for a redox flow battery power module, comprising: a negative endplate and a positive endplate, a plurality of cells positioned between the negative endplate and the positive endplate, each of the plurality of cells including a single positive electrode, a membrane frame assembly, a single mesh spacer, and a bipolar plate frame assembly, and wherein the bipolar plate frame assembly is affixed to the membrane frame assembly by a thermal weld. In a first example of the system, the negative endplate includes a negative tab terminal and the positive endplate includes a positive tab terminal, and wherein the negative tab terminal and the positive tab terminal both protrude past a vertical edge of the negative endplate and positive endplate respectively. In a second example of the system, optionally including the first example, the positive tab terminal and the negative tab terminal are both positioned on a same side of the redox flow battery power module. In a third example of the system, optionally including one or both of the first and second examples, the positive endplate, negative endplate, and the plurality of cells each include a plurality of slot openings configured to receive a bolt of a leaf spring system. In a fourth example of the system, optionally including one or more or each of the first through third examples, the plurality of slot openings of the positive endplate, negative endplate and the plurality of cells are aligned with each other in a plane perpendicular to a stacking direction. In a fifth example of the system, optionally including one or more or each of the first through fourth examples, a single bipolar plate is affixed to the bipolar plate frame assembly by a thermal weld and a single membrane is affixed to the membrane frame assembly by a thermal weld. In a sixth example of the system, optionally including one or more or each of the first through fifth examples, the negative endplate includes a negative current collector affixed to a frame of the negative endplate by a dome of the frame. In a seventh example of the system, optionally including one or more or each of the first through sixth examples, the positive endplate includes a positive current collector affixed to a frame of the positive endplate by a dome of the frame.

The disclosure also provides support for a redox flow battery power module, comprising: a first pressure plate, a positive endplate in face sharing contact with the first pressure plate, a membrane frame assembly of a first cell of a plurality of cells in face sharing contact with the positive endplate and affixed to the positive endplate by a thermal weld, a bipolar plate frame assembly of a second cell of the plurality of cells in face sharing contact affixed to a membrane frame assembly of the second cell by a thermal weld, a negative endplate in face sharing contact with the bipolar plate frame assembly and affixed to the bipolar plate frame assembly by a thermal weld, and a second pressure plate in face sharing contact with the negative endplate. In a first example of the system, the first pressure plate includes electrolyte inlets and electrolyte outlets. In a second example of the system, optionally including the first example, electrolyte is configured to flow from horizontally from the electrolyte inlets the first pressure plate to the second pressure plate, vertically through the redox flow battery power module, and horizontally from the second pressure plate to the electrolyte outlets of the first pressure plate. In a third example of the system, optionally including one or both of the first and second examples, the positive endplate and the negative endplate each include a single monopolar plate, a foil, a collector and a polymer insulating layer. In a fourth example of the system, optionally including one or more or each of the first through third examples, the single monopolar plate and the polymer insulating layer are each affixed to the positive endplate and/or the negative endplate by a thermal weld.

FIGS. 2A-10C show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. FIGS. 2A-10C are drawn approximately to scale, although other dimensions or relative dimensions may be used.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A cell of a redox flow battery system, comprising:
a membrane frame assembly;
a bipolar plate frame assembly;
a thermal weld positioned between the membrane frame assembly and the bipolar plate frame assembly, the thermal weld including material from a frame of the membrane frame assembly and a frame of the bipolar plate frame assembly; and
an electrolyte channel between the membrane frame assembly and the bipolar plate frame assembly delineated by channel ridges of the frame of the membrane frame assembly and channel ridges of the frame of bipolar plate frame assembly, and wherein the electrolyte channel is positioned adjacent to the thermal weld in a plane perpendicular to a stacking direction of the cell.

2. The cell of claim 1, wherein adhesive is not present at an interface between the membrane frame assembly and the bipolar plate frame assembly.

3. The cell of claim 1, wherein the membrane frame assembly and the bipolar plate frame assembly are formed of substantially the same thermoplastic materials.

4. The cell of claim 3, wherein substantially the same thermoplastic materials have substantially a same coefficient of thermal expansion (CTE) and elastic modulus.

5. The cell of claim 1, wherein the frame of the membrane frame assembly and the frame of the bipolar plate frame assembly include U-shaped protrusions configured to receive an alignment rod to align the frame of the membrane frame assembly with the frame of the bipolar plate frame assembly.

6. The cell of claim 1, wherein the frame of the membrane frame assembly and the frame of the bipolar plate frame assembly include semicircle protrusions configured to align the frame of the membrane frame assembly with the frame of the bipolar plate frame assembly.

7. The cell of claim 1, wherein the cell further includes a channel flash trap between the membrane frame assembly and the bipolar plate frame assembly and delineated on one side by the thermal weld, the channel flash trap configured to receive overflow material from the thermal weld.

8. A redox flow battery power module, comprising:
a negative endplate and a positive endplate;
a plurality of cells positioned between the negative endplate and the positive endplate, each of the plurality of cells including a single positive electrode, a membrane frame assembly, a single mesh spacer, and a bipolar plate frame assembly; and
wherein the bipolar plate frame assembly is affixed to the membrane frame assembly by a thermal weld.

9. The redox flow battery power module of claim 8, wherein the negative endplate includes a negative tab terminal and the positive endplate includes a positive tab terminal, and wherein the negative tab terminal and the positive tab terminal both protrude past a vertical edge of the negative endplate and positive endplate respectively.

10. The redox flow battery power module of claim 9, wherein the positive tab terminal and the negative tab terminal are both positioned on a same side of the redox flow battery power module.

11. The redox flow battery power module of claim 8, wherein the positive endplate, negative endplate, and the plurality of cells each include a plurality of slot openings configured to receive a bolt of a leaf spring system.

12. The redox flow battery power module of claim 11, wherein the plurality of slot openings of the positive endplate, negative endplate and the plurality of cells are aligned with each other in a plane perpendicular to a stacking direction.

13. The redox flow battery power module of claim 8, wherein a single bipolar plate is affixed to the bipolar plate frame assembly by a thermal weld and a single membrane is affixed to the membrane frame assembly by a thermal weld.

14. The redox flow battery power module of claim 8, wherein the negative endplate includes a negative current collector affixed to a frame of the negative endplate by a dome of the frame.

15. The redox flow battery power module of claim 8, wherein the positive endplate includes a positive current collector affixed to a frame of the positive endplate by a dome of the frame.

16. A redox flow battery power module, comprising:
a first pressure plate;
a positive endplate in face sharing contact with the first pressure plate;
a membrane frame assembly of a first cell of a plurality of cells in face sharing contact with the positive endplate and affixed to the positive endplate by a thermal weld;
a bipolar plate frame assembly of a second cell of the plurality of cells in face sharing contact affixed to a membrane frame assembly of the second cell by a thermal weld;
a negative endplate in face sharing contact with the bipolar plate frame assembly and affixed to the bipolar plate frame assembly by a thermal weld; and
a second pressure plate in face sharing contact with the negative endplate.

17. The redox flow battery power module of claim 16, wherein the first pressure plate includes electrolyte inlets and electrolyte outlets.

18. The redox flow battery power module of claim 17, wherein electrolyte is configured to flow from horizontally from the electrolyte inlets the first pressure plate to the second pressure plate, vertically through the redox flow battery power module, and horizontally from the second pressure plate to the electrolyte outlets of the first pressure plate.

19. The redox flow battery power module of claim 16, wherein the positive endplate and the negative endplate each include a single monopolar plate, a foil, a collector and a polymer insulating layer.

20. The redox flow battery power module of claim 19, wherein the single monopolar plate and the polymer insulating layer are each affixed to the positive endplate and/or the negative endplate by a thermal weld.
